(19) United States
(12) Patent Application Publication
(10) Pub. No.: US 2026/0131682 A1
(43) Pub. Date: May 14, 2026

(54) INTEGRATED PORTABLE SPARE WHEEL AND TIRE CHARGING SYSTEM

(71) Applicant: Ford Global Technologies, LLC, Dearborn, MI (US)

(72) Inventors: Keith Weston, Canton, MI (US); Todd Ansbacher, Westland, MI (US); John Robert Van Wiemeersch, Novi, MI (US)

(73) Assignee: Ford Global Technologies, LLC, Dearborn, MI (US)

(21) Appl. No.: 18/943,658

(22) Filed: Nov. 11, 2024

(51) Int. Cl. B60L 53/38; B60L 53/12; B60L 53/16

(52) U.S. Cl. CPC B60L 53/38; B60L 53/12; B60L 53/16

(57) ABSTRACT

Systems and methods for a portable spare wheel and tire inductive charging device are provided. A portable spare wheel and tire inductive charging device includes a receiving coil that can be coupled to a transmitting coil of an inductive charging source to receive power from the inductive charging source and transfer that power to a vehicle. The spare wheel and tire inductive charging device may be connected to a vehicle via a power cable. The portable spare wheel and tire inductive charging device can be used by multiple vehicles to receive charge from a stationary inductive power source. The spare wheel and tire inductive charging device may also include a transmitter coil that couples to a receiver coil of the vehicle to transmit power to the vehicle.

### FIELD

The present disclosure relates to the field of charging electric and/or hybrid vehicles. Specifically, embodiments of the present disclosure relate to an integrated portable spare wheel and tire charging system.

### BACKGROUND

Static wireless charging for electric and hybrid vehicles is an upcoming technology. The static wireless charging technology enables an electric or a hybrid vehicle to charge while parked over a charging pad. However, fully wireless charging systems often have lower efficiency compared to traditional plug-in chargers.

Proper alignment between the vehicle and the charging pad is desirable for efficient power transfer. Misalignment can significantly reduce charging efficiency, and the presence of large air gaps between the charging pad and the vehicle can reduce the efficiency of power transfer. In addition, traditional wireless charging systems for vehicles are bulky and make them less practical for portable charging applications.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 illustrates an environment in which embodiments of the present disclosure can be implemented.

FIG. 2 illustrates a block diagram of a vehicle according to an embodiment of the present disclosure.

FIG. 3 illustrates an integrated wheel and tire portable charging system according to an embodiment of the present disclosure.

FIG. 4 illustrates a cross-sectional view of the integrated wheel and tire portable charging system according to an embodiment of the present disclosure.

FIG. 5 illustrates a system for charging a vehicle using an integrated portable wheel and tire charging system according to an embodiment of the present disclosure.

FIGS. 6A and 6B illustrate a method for charging a vehicle according to another embodiment of the present disclosure.

FIG. 7 illustrates another method for charging a vehicle according to an embodiment of the present disclosure.

FIG. 8 illustrates a flow diagram for a process of charging a vehicle according to an embodiment of the present disclosure.

FIG. 9 illustrates a block diagram of a server according to an embodiment of the present disclosure.

### DETAILED DESCRIPTION

### Overview

The present disclosure describes systems and methods for a portable spare wheel and tire inductive charging system.

Embodiments of the present disclosure provide a method for the use of a portable spare wheel and tire charging system. For example, a method may include orienting a first vehicle over (e.g., in close proximity to) an inductive charging source and the first vehicle placing a portable spare wheel and tire inductive charging device over the inductive charging source. The method further includes the first vehicle disconnecting from the portable spare wheel and tire inductive charging device. The method may then include placing a second vehicle proximate to the portable spare wheel and tire inductive charging device. Thereafter, the portable spare wheel and tire inductive charging device receives power from the inductive charging source and transfers the power to the second vehicle.

In another instance, a system may include a first vehicle and a portable spare wheel and tire inductive charging device that is attached to the first vehicle. The system further includes an inductive charging source. The first vehicle of the system is configured to orient over (e.g., in close proximity to) the inductive charging source and place (e.g., position) the portable spare wheel and tire charging device over the inductive charging source. The first vehicle then physically and electrically disconnects from the portable spare wheel and tire charging device and moves away from the inductive charging source.

In yet another instance, a vehicle may be provided. The vehicle includes a portable spare wheel and tire inductive charging device, one or more sensors, and one or more processors coupled to the one or more sensors. The vehicle is operable to detect, using the one or more sensors, one or more alignment features associated with an inductive charging source and orient, itself over (e.g., in close proximity to) an inductive charging source using the one or more alignment features. The vehicle may then place (e.g., position) the portable spare wheel and tire inductive charging device over the inductive charging source and move away from the portable spare and tire inductive charging device.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

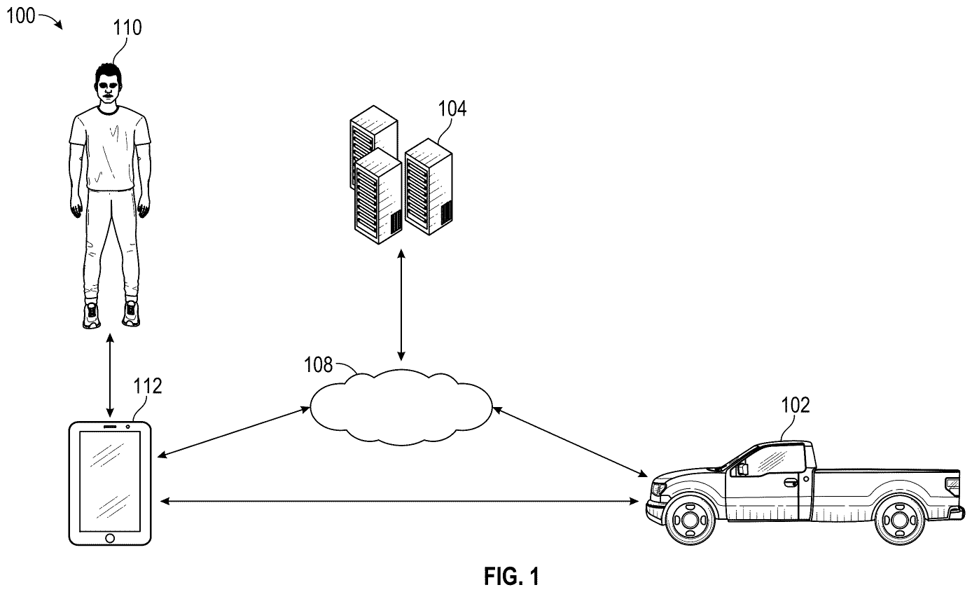

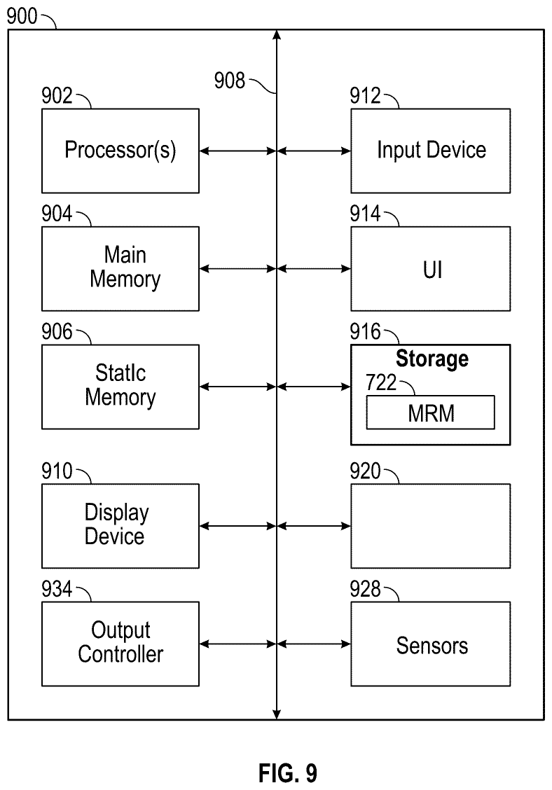

FIG. 1 illustrates an environment 100 in which the embodiments of the present disclosure may be implemented. The vehicle 102 can be any passenger or commercial vehicle such as a car, truck, tanker, bus, or the like. The environment 100 may also include a control server 104. The control server 104 may be part of a cloud-based computing infrastructure and may be associated with and/or include a Telematics Service Delivery Network (SDN) that provides digital data services to the vehicle 102. Details of the control server 104 are provided below with reference to FIG. 9.

The environment 100 may also include a user device 112. The user device 112 may be one of a portable phone, a tablet, a personal computer, a smart key fob, or the like. The user device 112 may be associated with a user 110 of the vehicle 102. The user 110 may be a driver of the vehicle 102 or a passenger in the vehicle 102. The user device 112 may receive information from the vehicle 102 and/or the control server 104. The user device 112 may have a specialized application installed on it that can interface with the vehicle 102 to download and display various types of vehicle-generated information and other control data. In one embodiment, the vehicle 102 may directly communicate with the user device 112 to send and receive data without the need for the network 108 and/or the server 104.

The environment 100 may further include a network 108. The network 108 illustrates an example communication infrastructure in which the connected devices discussed in various embodiments of this disclosure may communicate. The network 108 may be and/or include the Internet, a private network, public network or other configuration that operates using any one or more known communication protocols such as, for example, transmission control protocol/Internet protocol (TCP/IP), Bluetooth®, Bluetooth® low Energy (BLE), Wi-Fi based on the Institute of Electrical and Electronics Engineers (IEEE) standard 802.11, ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

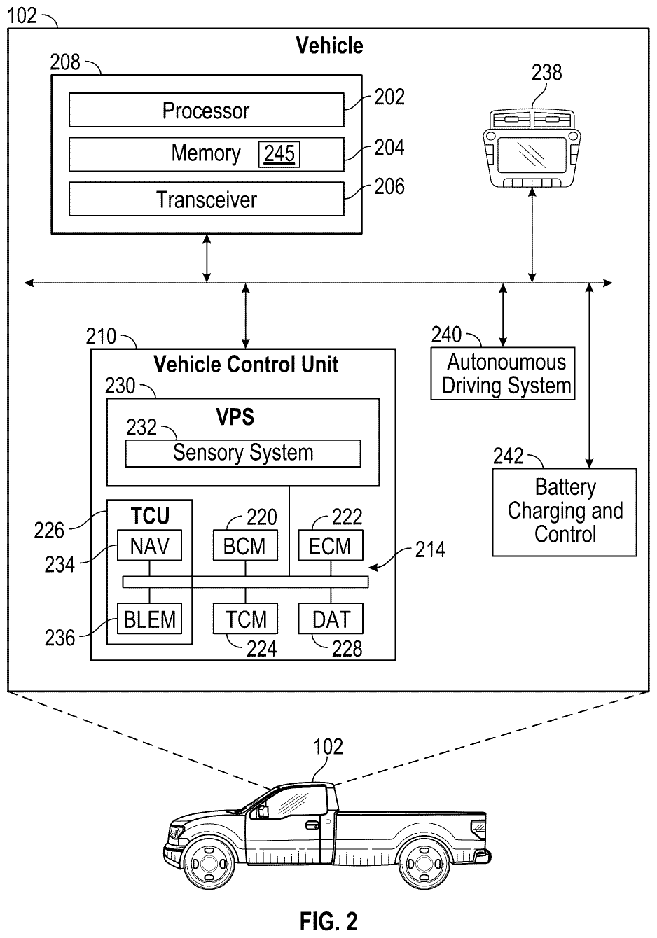

The vehicle 102 may include a plurality of units including, but not limited to, an automotive computer, a Vehicle Control Unit (VCU), and a detection unit. Details of the vehicle 102 are provided below in reference to FIG. 2.

FIG. 2 illustrates a block diagram of the vehicle 102 in which embodiments of the present disclosure can be implemented. The vehicle 102 may include a plurality of units including, but not limited to, an automotive computer 208, a Vehicle Control Unit (VCU) 210, and an infotainment unit 238. The VCU 210 may include a plurality of Electronic Control Units (ECUs) 214 disposed in communication with the automotive computer 208.

In some embodiments, a user device, such as a mobile phone, a laptop computer, a smart fob, or the like may be configured to connect with the automotive computer 208, which may communicate via one or more wireless connection(s), and/or may connect with the vehicle 102 directly by using near field communication (NFC) protocols, Bluetooth® protocols, Wi-Fi, Ultra-Wideband (UWB), and other possible data connection and sharing techniques.

The automotive computer 208 may be installed anywhere in the vehicle 102, in accordance with the disclosure. The automotive computer 208 may be or include an electronic vehicle controller, having one or more processor(s) 202, one or more memory devices 204, and one or more transceivers 206.

The processor(s) 202 may be disposed in communication with one or more memory devices disposed in communication with the respective computing systems (e.g., the memory 204 and/or one or more external databases not shown in FIG. 2). The processor(s) 202 may utilize the memory 204 to store programs in code and/or to store data for performing operations in accordance with the disclosure. The memory 204 may be a non-transitory computer-readable storage medium or memory storing a vehicle control program code. The memory 204 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.). In some embodiments, memory 204 may include a module 245 that can implement the various embodiments of the present disclosure. Module 245 may include instructions that can be executed by the processor 202 to realize the various embodiments of the present disclosure.

Automotive computer 208 may also include a transceiver 206. The transceiver 206 may be configured to receive information/inputs from one or more external devices or systems, e.g., a user device 208, an external server, and/or the like. Further, the transceiver 206 may transmit notifications, requests, signals, etc. to the external devices or systems. In addition, the transceiver 206 may be configured to receive information/inputs from vehicle components such as the vehicle sensory system 232, one or more ECUs 214, and/or the like. Further, the transceiver 206 may transmit signals (e.g., command signals) or notifications to the vehicle components such as the BCM 220, the infotainment system 238, and/or the like.

In some embodiments, the VCU 210 may share a power and/or communications bus with the automotive computer 208 and may be configured and/or programmed to coordinate the data between vehicle systems, connected servers and/or the like. The VCU 210 may include or communicate with any combination of the ECUs 214, such as, for example, the BCM 220, an Engine Control Module (ECM) 222, a Transmission Control Module (TCM) 224, a Telematics Control Unit (TCU) 226, a Driver Assistance Technologies (DAT) controller 228, etc. The VCU 210 may further include and/or communicate with a Vehicle Perception System (VPS) 230, having connectivity with and/or control of one or more vehicle sensory system(s) 232. The vehicle sensory system 232 may include one or more vehicle sensors including, but not limited to, a Radio Detection and Ranging (RADAR or “radar”) sensor configured for detection and localization of objects inside and outside the vehicle 102 using radio waves, sitting area buckle sensors, sitting area sensors, a Light Detecting and Ranging (“LIDAR”) sensor, door sensors, proximity sensors, temperature sensors, wheel sensors, one or more ambient weather or temperature sensors, vehicle interior and exterior cameras, steering wheel sensors, etc. The sensors that are part of the vehicle sensory system 232 may be coupled to the vehicle 102 at one or more locations and in one or more manner. For example, the various sensors of the vehicle sensory system 232 may be integrated into the various subsystems of the vehicle 102, such as doors, mirrors, roof, etc. or attached to the vehicle 102 using an appropriate mounting mechanism. In some embodiments, the various sensors of the vehicle sensory system 232 may be located at the front, back, sides, top, bottom, and underneath the vehicle 102. The location of a sensor may depend on its function. For example, a sensor that monitors the area underneath the vehicle may be connected to a bottom surface of the vehicle 102 while a sensor that can monitor an area to any side of the vehicle 102 may be mounted or integrated into the doors of the vehicle 102. Vehicle sensory system 232 may also include one or more sensors such as cameras, Lidar, and/or accelerometers that are coupled to various mechanical components and/or systems of the vehicle 102. One skilled in the art will realize that the sensors may be coupled to the vehicles in various different ways and locations other than the ones mentioned above.

In some embodiments, the VCU 210 may control vehicle operational aspects and implement one or more instruction sets received from the server 104, the user device 112, or from one or more instruction sets stored in the memory 204.

The TCU 226 may be configured and/or programmed to provide vehicle connectivity to wireless computing systems onboard and off board the vehicle 102, and may include a Navigation (NAV) receiver 234 for receiving and processing a GPS signal, a BLE® Module (BLEM) 236, a Wi-Fi transceiver, a UWB transceiver, and/or other wireless transceivers (not shown in FIG. 2) that may be configurable for wireless communication (including cellular communication) between the vehicle 102 and other systems (e.g., a vehicle key fob (not shown in FIG. 2), an external server, a user device, etc.), computers, and modules. The TCU 226 may be in communication with the ECUs 214 by way of a wired or wireless bus. In some aspects, the TCU 226 may be configured to determine a real-time vehicle geolocation, e.g., via the NAV receiver 234.

The ECUs 214 may control aspects of vehicle operation and communication using inputs from human drivers, inputs from the automotive computer 208, and/or via wireless signal inputs received via the wireless connection(s) from other connected devices, such as the server 206, among others.

The BCM 220 generally includes integration of sensors, vehicle performance indicators, and variable reactors associated with vehicle systems, and may include processor-based power distribution circuitry that may control functions associated with the vehicle body such as lights, windows, security, camera(s), audio system(s), speakers, wipers, door locks and access control, various comfort controls, etc. The BCM 220 may also operate as a gateway for bus and network interfaces to interact with remote ECUs (not shown in FIG. 2).

The DAT controller 228 and/or the autonomous driving system 240 may provide Level-1 through Level-5 automated driving and driver assistance functionality that may include, for example, active parking assistance, vehicle backup assistance, and/or adaptive cruise control, among other features. The DAT controller 228 may also provide aspects of user and environmental inputs usable for user authentication.

In some embodiments, the automotive computer 208 may connect with an infotainment system 238 (or a vehicle Human-Machine Interface (HMI)). The infotainment system 238 may include a touchscreen interface portion, and may include voice recognition features, biometric identification capabilities that may identify users based on facial recognition, voice recognition, fingerprint identification, or other biological identification means. In other aspects, the infotainment system 238 may be further configured to receive user instructions via the touchscreen interface portion, and/or output or display notifications, navigation maps, etc. on the touchscreen interface portion. In some embodiments, the user device 112 may act as the HMI interface for the vehicle 102.

In some embodiments, the vehicle 102 may include a battery charging and control unit 242. The battery charging and control unit 242 may include a battery management system that may (i) continuously monitor the state of charge (SOC), state of health (SOH), and temperature of the battery cells, (ii) ensure all battery cells are balanced to prevent overcharging or deep discharging, which can degrade the cells, and (iii) protect against over-voltage, under-voltage, over-current, and thermal runaway. The battery charging and control unit 242 may further include power conversion mechanism that converts alternating current (AC) from the grid or any other charger to direct current (DC) required by the battery and manages the voltage levels within the vehicle, ensuring the high-voltage battery of the vehicle can power low-voltage systems like lights and infotainment. The battery charging and control unit 242 may also include thermal management devices such as cooling and heating systems to maintain optimal battery temperature and operating conditions. In an embodiment, the memory 204 may store battery algorithms related to predictive maintenance and optimization for the high-voltage battery.

The computing system architecture of the automotive computer 208 and/or the VCU 210 may omit certain computing modules. It should be readily understood that the computing environment depicted in FIG. 2 is an example of a possible implementation according to the present disclosure, and thus, it should not be considered as limiting or exclusive.

In addition to the components noted above, the vehicle 102 may have numerous mechanical systems and sub-systems. A chassis or frame may form the backbone of the vehicle 102 and support the body and other components of the vehicle 102. The vehicle 102 may include an engine that converts fuel into mechanical power, propelling the vehicle forward. The engine includes various components such as the engine block, pistons, valves, and spark plugs. The vehicle 102 may also include a transmission system. The transmission system transfers the engine's power to the wheels. It includes the clutch, gearbox, driveshaft, and differentials, among other components. The transmission adjusts the power output to suit the vehicle's speed and load. The vehicle 102 may also include a suspension system. The suspension system absorbs shocks and maintains contact between the tires and the road, providing a smooth ride. It includes components such as springs, shock absorbers, and linkages. The vehicle 102 also includes a vehicle stopping system that allows the driver to slow down or stop the vehicle 102. It includes components like pedals, master cylinder, lines, and pads or shoes. The vehicle 102 also includes a steering system that enables the driver to guide the car. The steering system includes components such as the steering wheel, steering column, rack and pinion, and tie rods. The vehicle 102 may also include an exhaust system that removes and filters the waste gases produced by the engine. It includes the exhaust manifold, catalytic converter, muffler, and tailpipe, among other components. The vehicle 102 also includes a cooling system that prevents the engine and/or battery from overheating. It includes components such as the radiator, water pump, thermostat, and coolant. The vehicle 102 also includes a cooling system that stores and supplies fuel to the engine. It includes the fuel tank, fuel pump, fuel filter, and fuel injectors. An electrical system of the vehicle 102 powers the car's electrical components. It may include the battery, alternator, starter motor, and wiring. The Heating, Ventilation, and Air Conditioning (HVAC) system controls the temperature inside the vehicle 102. It includes the heater core, blower motor, and air conditioning compressor. In some embodiments, the vehicle may be an electric vehicle (EV) or hybrid vehicle, and in either case some of the aforementioned components would be replaced by an electric motor and a high-voltage battery. All of the mechanical components working together ensure that the vehicle operates optimally.

The traditional method for charging electric or hybrid vehicles is to plug the vehicle into a wall socket or to a dedicated charging station such as a level II charger or a commercial high-voltage charger. In all these instances, the chargers are static and are fixed at a certain location such as a garage or a parking lot. In order to charge a vehicle, the vehicle has to be driven to one of these charging stations and a power cable is physically plugged into a charging port of the vehicle. Recently some mobile charging robot systems have been proposed, however, these mobile charging systems are inefficient and are not integrated with the vehicle and thus suffer from some of the same disadvantages as the traditional static charging systems.

Embodiments of the present disclosure provide a portable charging system that is integrated into the spare wheel of a vehicle creating a compact and portable charging system that stays with the vehicle and can act as a charge source for the vehicle high-voltage battery. In addition, this integrated spare wheel portable charging system can be disconnected from the vehicle and used to charge other vehicles and accessories, and thus, provide a versatile charging system.

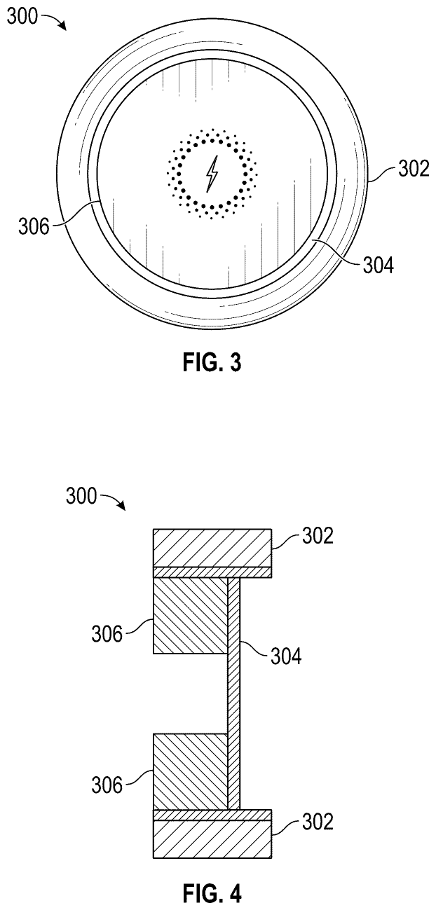

FIG. 3 illustrates an integrated spare wheel portable charging system 300 according to an embodiment of the present invention. Most vehicles such as pick-up trucks, SUVs, etc. have a spare wheel included in the vehicle. While full-size spare wheels have seen a steady decline from being included in vehicles, many vehicles still include a smaller spare wheel. The spare wheel portable charging system 300 may include a wheel 304 surrounded by a tire 302. The wheel 302 may include one or more standard components such as a rim, spokes, barrel, valve stem, lug holes, and a center cap. The spare wheel portable charging system 300 further includes an inductive charging device 306. The inductive charging device 306 may include a receiver coil that captures the alternating magnetic field and converts it into AC voltage. The inductive charging device 306 may further include a receiver rectifier circuit that converts the induced AC voltage to DC voltage. The inductive charging device 306 may also include a voltage controller that ensures that the DC voltage is suitable for charging the vehicle high-voltage battery. The DC voltage may be provided by the spare wheel portable charging system 300. FIG. 4 illustrates a cross-sectional view of the spare wheel portable charging system 300. As can be seen, the inductive charging device 306 may be placed at the center of the wheel 304. In an embodiment, the inductive charging device 306 may be integrated with the center cap and the spokes of the wheel 304. The integrated spare wheel portable charging system 300 may be incorporated into the vehicle 102 in one of multiple ways. In an embodiment, the integrated spare wheel portable charging system 300 may be mounted to an underside of the vehicle 200 using spare tire hoist. In another embodiment, the integrated spare wheel portable charging system 300 may be placed inside the trunk of the vehicle 102. In yet another embodiment, the integrated spare wheel portable charging system 300 may be mounted on a rear door of the vehicle 102. In another embodiment, the integrated spare wheel portable charging system 300 may be mounted on the roof of the vehicle 102 or placed inside the vehicle 102 in a dedicated compartment within the vehicle 102.

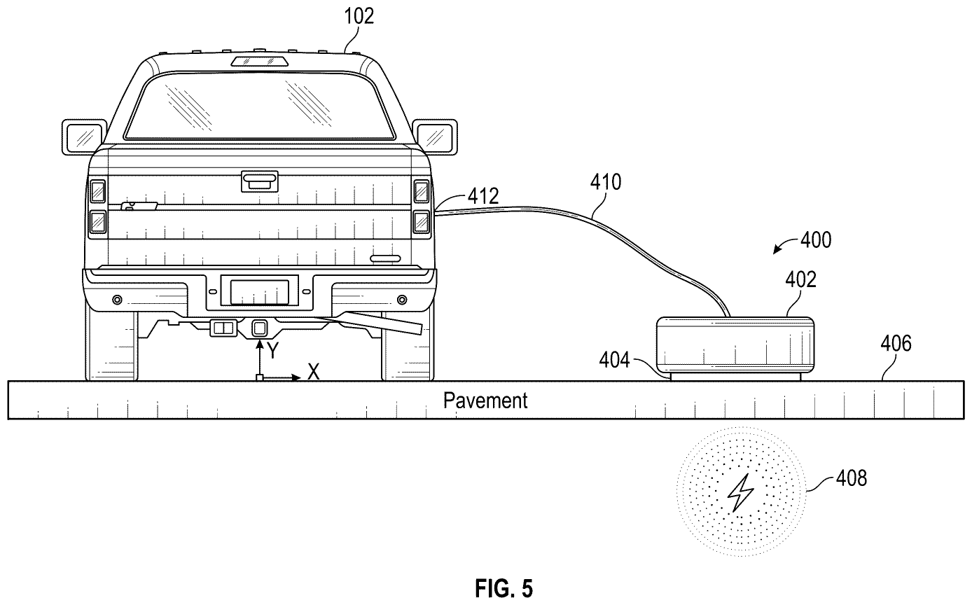

FIG. 5 illustrates the use of an integrated portable spare wheel and tire inductive charging system 400 according to an embodiment of the present disclosure. The integrated portable spare wheel and tire inductive charging system 400 may include a spare wheel 402 that integrates an inductive charging device. The inductive charging device may have a receiver coil 404 that is mounted to a surface of the spare wheel 402 and is exposed to an external environment of the spare wheel 402. In some embodiments, the receiver coil in integrated in the spare wheel 402, and in other embodiments, the receiver coil is detachably coupled to the spare wheel 402. The integrated portable spare wheel and tire inductive charging system 400 may also include a power cable 410 that is removably attached at one end to an output port of the inductive charging device of the spare wheel 402. The other end of the power cable 412 may include an appropriate connector to mate with a charging port 412 of the vehicle 102. In operation, the vehicle 102 may drive over a floor 406 and position itself over (not shown) an inductive charging source 408 that, in certain embodiments, may be located underneath or on the floor 406. The inductive charging source 408 may include a transmitter coil that generates an electromagnetic field when an alternating current passes through it. The inductive charging source 408 may also include a power supply that converts AC from the grid to the appropriate voltage and current levels needed by the transmitter coil and provides electrical power to the transmitter coil. The inductive charging source 408 may also include a control unit to manage power transfer between the transmitter and receiver coils using communication and control protocols.

Once the vehicle positions itself over the inductive charging source 408, the vehicle may automatically place itself or a user of the vehicle may place the spare wheel 402 such that the receiver coil 404 of the integrated portable spare wheel and tire inductive charging system 400 is aligned over the transmitter coil of the inductive charging source 408. Thereafter the vehicle 102 may be parked at a distance from the inductive charging source 408. In some embodiments, the vehicle may autonomously drive itself to a parking location. The distance at which the vehicle may park may depend on the length of the power cable 410. Once the vehicle 102 is parked at the appropriate location, the inductive charging source 408 may then start the power transfer to the integrated portable spare wheel and tire inductive charging system 400. In some embodiments, the integrated portable spare wheel and tire inductive charging system 400 may transfer power to the vehicle 102 via the power cable 410 to charge the vehicle battery. In another embodiments, the integrated portable spare wheel and tire inductive charging system 400 may transfer power to a different vehicle 102 (than the one which held the charging system 400) via the power cable 410 to charge the different vehicle 201 battery. In other embodiments, the integrated portable spare wheel and tire inductive charging system 400 may also have a power storage device and a transmitter coil. In this instance, once the power storage device of the integrated portable spare wheel and tire inductive charging system 400 is fully charged, the integrated portable spare wheel and tire inductive charging system 400 may be inductively coupled to the vehicle 102 via the transmitter coil of the integrated portable spare wheel and tire inductive charging system 400 being aligned with a receiver coil of the vehicle 102, which is coupled to the battery of the vehicle 102. Once coupled to the vehicle, the integrated portable spare wheel and tire inductive charging system 400 may transfer power from its power storage device to the vehicle battery via its transmitter coil and the vehicle receiving coil. Once the vehicle charging is completed, the integrated portable spare wheel and tire inductive charging system 400 may be reattached to a vehicle 102.

In some embodiments, the inductive charging source 408 may be controlled by a remote server (e.g., server 104). In this instance, once the vehicle 102 (or the user of the vehicle 102) places the spare wheel 402 over the inductive charging source 408, as explained above and/or when the power cable 410 is connected to the vehicle charging port 412, the vehicle may send a message to the remote server indicating that the spare wheel 402 has been placed over the inductive charging source 408. In other instances, once the spare wheel 402 is placed over the inductive charging source 408, the remote server may detect the placement (e.g., via sensors coupled to the inductive charging source 408 and/or the spare wheel 402 and the remote server) of the spare wheel 402 over the inductive charging source 408. Once the remote server receives the message from the vehicle or detects the placement, the remote server may send a message to the inductive charging source 408 to activate the inductive charging source 408. Upon activation, the inductive charging source 408 may start transferring power to the integrated portable spare wheel and tire inductive charging system 400.

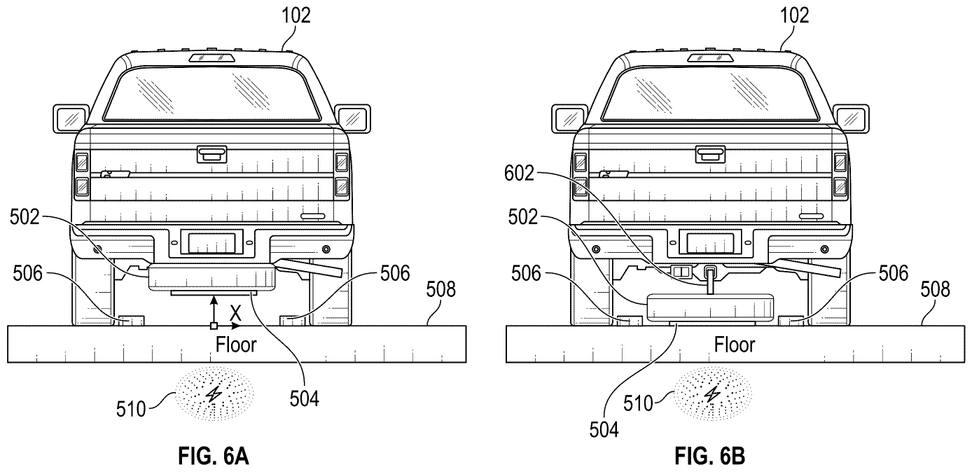

FIGS. 6A and 6B illustrate the use of the integrated portable spare wheel and tire inductive charging system according to another embodiment of the present disclosure. In this embodiment, the vehicle 102 includes a spare wheel and tire inductive charging device 502 that includes a receiver coil 504. In an embodiment, the spare wheel and tire inductive charging device 502 can be mounted to an underside of the vehicle 102. In other embodiments, the spare wheel and tire inductive charging device 502 may be located inside the trunk or some other area of the vehicle 102. In this embodiment, the vehicle 102 may drive over an inductive charging source 510 that may be disposed under or on a floor 508. The inductive charging source 510 may be similar in construction to the inductive charging source 408 described above. In order for the vehicle to drive over the inductive charging source 510, the vehicle 102 may need a minimum ground clearance between the underside of the vehicle 102 and the floor 508. For vehicles that may not have the requisite ground clearance, the spare wheel and tire inductive charging device 502 may be located such that driving over the inductive charging source 510 is not needed.

In order to optimize the energy transfer from the inductive charging source 510 to the spare wheel and tire inductive charging device 502, it is important to properly align the receiver coil 504 with the transmitter coil of the inductive charging source 510. Since the inductive charging source 510 is located under the floor and the spare wheel and tire inductive charging device 502 is located underneath the vehicle 102, it may be difficult for the driver of the vehicle to correctly ascertain the correct orientation for the vehicle 102 in order to properly align the receiver coil 504 over the transmitter coil. In order to assist the driver of the vehicle 102 in properly aligning the receiver coil 504 with the transmitter coil of the inductive charging source 510, there may be one or more alignment features 506 placed on the floor 508. These alignment features help with the proper orientation of the vehicle 102 such that the receiver coil 504 is properly aligned with the transmitter coil of the inductive charging source 510. In one embodiment, the alignment features 506 may be specialized tags that can be recognized by an under-body camera of the vehicle 102. The HMI system of the vehicle 102 may display these tags on a screen associated with the HMI system and the driver may use the tags to properly guide the vehicle 102. In another embodiment, ultrasonic sensors on the vehicle 102 may read/detect ultrasonic emissions from a transmitter placed on the floor 508 in order to provide guidance for the driver of the vehicle to correctly orient the vehicle 102 over the inductive charging source 510. In another embodiment, vehicle radar may be used to localize the inductive charger source 510.

Once the vehicle 102 is correctly oriented over the inductive charging source 510, the driver of the vehicle 102 may initiate a process to lower the spare wheel and tire inductive charging device 502 towards the ground. In some embodiments, the vehicle 102 may automatically initiate this process without any driver intervention once the vehicle is correctly oriented over the inductive charging source 510. In an embodiment, the vehicle 102 may initiate the process of lowering the spare wheel and tire inductive charging device 502 only after the vehicle 102 detects that it is in a parked state. The spare wheel and tire inductive charging device 502 may be attached to a spare tire joist 602. The spare tire joist 602 may be extended towards the floor 508 in order to move the spare wheel and tire inductive charging device 502 closer to the inductive charging source 510. Once the receiver coil 504 is at the appropriate distance from the transmitter coil of the inductive charging source 510 or when the receiver coil 504 is in physical contact with the transmitter coil of the inductive charging source 510, the extension of the spare wheel joist 602 may be stopped. After the vehicle 102 determines that spare wheel joist 602 is extended to the appropriate distance, the vehicle 102 may send a message to a controller of the inductive charging source 510. In an embodiment, the remote server 104 may function as the controller of the inductive charging source 510. After the controller receives the message from the vehicle 102, the controller may enable power to the inductive charging source 510. Thereafter, the spare wheel and tire inductive charging device 502 may start receiving power.

In one embodiment, the spare wheel and tire inductive charging device 502 may have its own power storage device, such as a battery. In other embodiments, the spare wheel and tire inductive charging device 502 may be connected to the high-voltage battery of the vehicle 102 via a power cable (e.g., the power cable 410 illustrated in FIG. 5). The vehicle 102 may then charge its high-voltage battery via the spare wheel and tire inductive charging device 502. Once the charging is complete or otherwise stopped, the spare tire joist 602 may be retracted back and the spare wheel and tire inductive charging device 502 is returned to its default location. In some embodiments, the vehicle 102 may send another message to the controller of the inductive charging source 510 indicating the end of the charging session. The controller may then terminate the power being supplied to the inductive charging source 510.

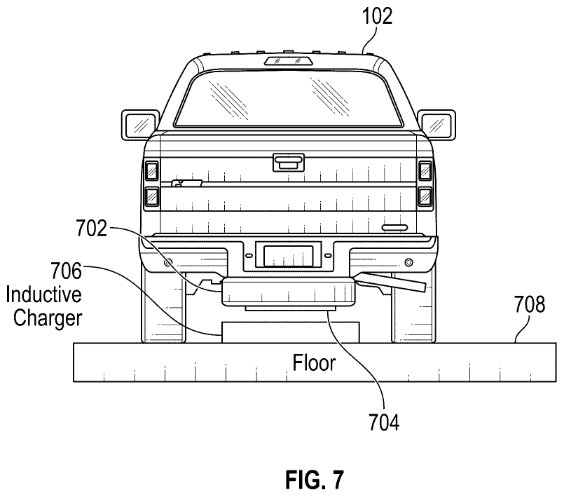

FIG. 7 illustrates use of a spare wheel and tire inductive charging device 702 according to another embodiment of the present invention. In this embodiment, an inductive charging source 706 may be placed above a floor 708. The spare wheel and tire inductive charging device 702 may include a receiver coil 704. In this instance, since the inductive charging source 706 is placed above the floor, there may not be a need to lower the spare wheel and tire inductive charging device 702. For vehicles having the appropriate ground clearance, the vehicle 102 may be oriented over the inductive charging source 706. Once the vehicle is properly oriented, the receiver coil 704 is automatically located at the right distance from the transmitter coil of the inductive charging source 706. In some embodiments, the inductive charging source 706 may be capable of being raised above the floor 708 in order to ensure the proper distance between the receiver coil 704 and the transmitter coil of the inductive charging source 706 or ensure that the receiver coil 704 is in physical contact with the transmitter coil of the inductive charging source 706.

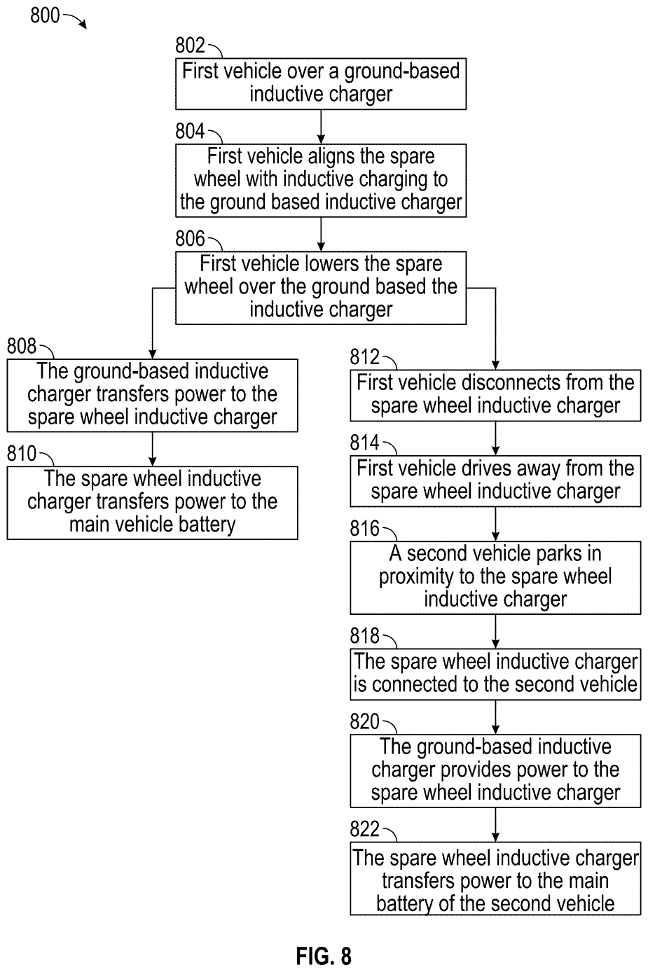

FIG. 8 is a flow chart for a process 800 for charging a vehicle using a spare wheel and tire inductive charging device according to an embodiment of the present invention. In an embodiment, process 800 may be performed by the vehicle 102 alone or by the vehicle 102 in conjunction with the server 104. At step 802, a first vehicle is oriented over a ground-based inductive charging source. The ground-based inductive charging source may either be located above a floor or underneath the floor as described above. At step 804, the first vehicle may align the spare wheel and tire inductive charging device with the ground-based inductive charging device so that power transfer may be started. At step 806, the vehicle may place the spare wheel and tire inductive charging device over the ground-based inductive charger by lowering the spare wheel and tire inductive charging device onto the ground-based inductive charging device). Once the spare wheel and tire inductive charging device is placed in physical contact with the ground-based inductive charging source or brought within the appropriate distance of the ground-based inductive charging source, the ground-based inductive charging source may start transferring power to the spare wheel and tire inductive charging device at step 808. The spare wheel and tire inductive charging device may then transfer the power to the battery of the first vehicle at step 810.

In another embodiment, the first vehicle may not need to be charged. Instead, the first vehicle may place the spare wheel and tire inductive charging device onto the ground-based inductive charging source and disconnect itself physically and electrically from the spare wheel and tire inductive charging device, at step 812. After the first vehicle has disconnected itself physically and electrically from the spare wheel and tire inductive charging device, the first vehicle may move away, driven by a user or autonomously, from the location, at step 814. Thereafter, a second vehicle may be placed in proximity of or over the spare wheel and tire inductive charging device, at step 816. The spare wheel and tire inductive charging device may then be electrically coupled to the second vehicle (e.g., using the power cable as described above) at step 818. After the second vehicle is coupled to the spare wheel and tire inductive charging device, the ground-based inductive charging source may start power transfer to the spare wheel and tire inductive charging device, at step 820. The spare wheel and tire inductive charging device may then transfer power to the second vehicle, at step 822. Thus, the spare wheel and tire inductive charging device may be used to charge multiple vehicles. In some instances, the spare wheel and tire inductive charging device may be physically attached to the second vehicle (or some other vehicle) upon completion of the charging session. The second vehicle may then transport the spare wheel and tire inductive charging device to a different location to be used for charging other vehicles. This will enhance the current vehicle charging infrastructure and provide greater flexibility in charging electric and/or hybrid vehicles.

FIG. 9 depicts a block diagram of an example control server 900, (e.g., control server 104 of FIG. 1) upon which any of one or more techniques (e.g., methods) may be performed or which may perform the methods described above in conjunction with the vehicle 102, in accordance with one or more example embodiments of the present disclosure. In other embodiments, the server 900 may operate as a standalone device or may be connected (e.g., networked) to other servers. In a networked deployment, the server 900 may operate in the capacity of a server machine, a client machine, or both in server-client network environments. In an example, the server 900 may act as a peer server in peer-to-peer (P2P) (or other distributed) network environments. The server 900 may be a personal computer (PC), a tablet PC, a set-top box (STB), a personal digital assistant (PDA), a mobile telephone, a smart key fob, a wearable computer device, a web appliance, a network router, a switch or bridge, or any machine capable of executing instructions (sequential or otherwise) that specify actions to be taken by that server, such as a base station. Further, while only a single server is illustrated, the term “server” shall also be taken to include any collection of servers that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific task when in operation. The configuring may occur under the direction of the execution units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The server (e.g., computer system) 900 may include a hardware processor 902 (e.g., a central processing unit (CPU), a graphics processing unit (GPU), a hardware processor core, or any combination thereof), a main memory 904 and a static memory 906, some or all of which may communicate with each other via an interlink (e.g., bus) 908. The server 900 may further include a graphics display device 910, an alphanumeric input device 912 (e.g., a keyboard), and a user interface (UI) navigation device 914 (e.g., a mouse). In an example, the graphics display device 910, alphanumeric input device 912, and UI navigation device 914 may be a touch screen display. The server 900 may additionally include a storage device (i.e., drive unit) 916, a network interface device/transceiver 920 coupled to antenna(s), and one or more sensors 928, such as a global positioning system (GPS) sensor, a compass, an accelerometer, or other sensor. The server 900 may include an output controller 934, such as a serial (e.g., universal serial bus (USB)), parallel, or other wired or wireless (e.g., infrared (IR)), near field communication (NFC), etc. connection to communicate with or control one or more peripheral devices (e.g., a printer, a card reader, etc.).

The storage device 916 may include a machine readable medium 922 on which is stored one or more sets of data structures or instructions (e.g., software) embodying or utilized by any one or more of the techniques or functions described herein. The instructions may also reside, completely or at least partially, within the main memory 904, within the static memory 906, or within the hardware processor 902 during execution thereof by the server 900. In an example, one or any combination of the hardware processor 902, the main memory 904, the static memory 906, or the storage device 916 may constitute machine-readable media.

While the machine-readable medium 922 is illustrated as a single medium, the term “machine-readable medium” may include a single medium or multiple media (e.g., a centralized or distributed database, and/or associated caches and servers) configured to store the one or more instructions.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the server 900 and that cause the server 900 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions may further be transmitted or received over a communications network using a transmission medium via the network interface device/transceiver 920 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 920 may include one or more physical jacks (e.g., Ethernet, coaxial, or phone jacks) or one or more antennas to connect to the communications network. In an example, the network interface device/transceiver 920 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the server 900 and includes digital or analog communications signals or other intangible media to facilitate communication of such software. The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

It is to be noted that the vehicle implements and/or performs operations, as described here in the present disclosure, in accordance with the owner manual and safety guidelines. In addition, any action taken by the vehicle owner/driver based on recommendations or notifications provided by the vehicle should comply with all the rules specific to the location and operation of the vehicle (e.g., Federal, state, country, city, etc.). The recommendation or notifications, as provided by the vehicle, should be treated as suggestions and only followed according to any rules specific to the location and operation of the vehicle. In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A system comprising:
a first vehicle;
a portable spare wheel and tire inductive charging device attached to the first vehicle, wherein the first vehicle is configured to:
orient the first vehicle over an inductive charging source;
position the portable spare wheel and tire charging device over the inductive charging source;
physically and electrically disconnect from the portable spare wheel and tire charging device; and
move the first vehicle away from the inductive charging source.

2. The system of claim 1 further comprising:
a second vehicle, wherein the second vehicle is configured to:
orient the second vehicle in proximity to the inductive charging source after the first vehicle has moved away;
detect electrical coupling between the portable spare wheel and charging device and the second vehicle; and
receive power from the portable spare wheel and tire charging device.

3. The system of claim 1, wherein the portable spare wheel and charging device receives power from the inductive charging source.

4. The system of claim 3, wherein the second vehicle is configured to, prior to receiving power from the portable spare wheel and tire charging device, send a message to a controller of the inductive charging source indicative of the electrical coupling between the portable spare wheel and charging device and the second vehicle.

5. The system of claim 1, wherein the portable spare wheel and tire inductive charging device is attached to the first vehicle using a spare tire joist that is configured to move between a first position and a second position, wherein the first position is separated from the second position by a vertical distance.

6. The system of claim 1, wherein the portable spare wheel and tire inductive charging device includes a power cable, and wherein the power cable is connected to an output port of the portable spare wheel and tire inductive charging device.

7. A vehicle comprising:
a portable spare wheel and tire inductive charging device;
one or more sensors; and
one or more processors coupled to the one or more sensors, wherein the vehicle is operable to:
detect, using the one or more sensors, one or more alignment features associated with an inductive charging source;
orient, using the one or more alignment features, the vehicle over an inductive charging source;
place the portable spare wheel and tire inductive charging device over the inductive charging source; and
move the vehicle away from the portable spare and tire inductive charging device.

8. The vehicle of claim 7, wherein the portable spare wheel and tire inductive charging device is connected to the first vehicle by a tire joist that can be moved between a first location and second location in a vertical direction.

9. The vehicle of claim 7, wherein the portable spare wheel and tire inductive charging device includes a receiver coil and power conversion circuit, wherein the receiver coil receives power from a first transmitter coil of the inductive charging source and the power conversion circuit converts the power to a direct current (DC) voltage.

10. The vehicle of claim 7, wherein the portable spare wheel and tire inductive charging device further includes a first receiver coil and a first transmitter coil, and the vehicle includes a second receiver coil, wherein the portable spare wheel and tire inductive charging device is further configured to receive power from the inductive charging source via the first receiver coil and transfer power to the vehicle via the first transmitter coil and the second receiver coil.

11. The vehicle of claim 7, wherein the portable spare wheel and tire inductive charging device includes a power cable, the power cable having a connector couplable to a corresponding connector of the vehicle.

12. The vehicle of claim 7, wherein the vehicle is further operable to send a message to a controller of the inductive charging source after placing the portable spare wheel and tire inductive charging device over the inductive charging source, the message causing the controller to enable power to the inductive charging source.

13. The vehicle of claim 7, wherein the vehicle is further operable to receive power from the inductive charging source via the portable spare wheel and tire inductive charging device.

14. A method comprising:
orienting a first vehicle over an inductive charging source;
placing, by the first vehicle, a portable spare wheel and tire inductive charging device in proximate the inductive charging source;
disconnecting the first vehicle from the portable spare wheel and tire inductive charging device;
placing a second vehicle proximate to the portable spare wheel and tire inductive charging device;
receiving, by the portable spare wheel and tire inductive charging device, power from the inductive charging source; and
transferring, by the portable spare wheel and tire inductive charging device, power to the second vehicle.

15. The method of claim 14, wherein the portable spare wheel and tire inductive charging device includes a receiving coil, and further comprising:
placing the portable spare wheel and tire inductive charging device in proximity the inductive charging source comprises aligning the receiving coil with a transmitting coil of the inductive charging source.

16. The method of claim 14, further comprising:
determining, by the second vehicle, that the portable spare wheel and tire inductive charging device is electrically coupled to the second vehicle prior to transferring the power to the second vehicle.

17. The method of claim 16, further comprising:
sending, by the second vehicle and based on determining that the portable spare wheel and tire inductive charging device is electrically coupled to the second vehicle, a message to a controller of the inductive charging source; and
enabling, by the controller, power to the inductive charging source, in response to the message.

18. The method of claim 14, wherein the portable spare wheel and tire inductive charging device is physically connected to the first vehicle, and wherein the disconnecting includes physically disconnecting the portable spare wheel and tire inductive charging device from the first vehicle.

19. The method of claim 14, wherein the portable spare wheel and tire inductive charging device includes a receiving coil and a transmitter coil.

20. The method of claim 14, further comprising:
determining, by the second vehicle, that a charging session is complete;
sending a message to a controller of the inductive charging source, wherein the message causes the controller to cease providing power to the inductive charging source.
